(19) United States
(12) Patent Application Publication
(10) Pub. No.: US 2014/0139495 A1
(43) Pub. Date: May 22, 2014

(54) SYSTEM FOR OPTIMIZING TOUCH TRACKS AND METHOD FOR OPTIMIZING TOUCH TRACKS

(71) Applicant: CHUNGHWA PICTURE TUBES, LTD., Taoyuan (TW)

(72) Inventor: Hu-Yi Liu, Taoyuan County (TW)

(73) Assignee: CHUNGHWA PICTURE TUBES, LTD., Taoyuan (TW)

(21) Appl. No.: 13/748,605

(22) Filed: Jan. 24, 2013

(30) Foreign Application Priority Data
Nov. 19, 2012 (TW) 101143096

(51) Int. Cl. G06F 3/041

(52) U.S. Cl. CPC G06F 3/0418
USPC 345/178

(57) ABSTRACT

A system for optimizing touch tracks includes a touch panel, a register, and a processor. The processor is used for receiving a plurality of touch signals of the touch panel, calculating a plurality of raw report points of the touch panel according to the plurality of touch signals, storing the plurality of raw report points in the register, utilizing a linear optimization method to generate an optimization curve corresponding to each raw report point of the plurality of raw report points according to previous i raw report points and following j raw report points of the plurality of raw report points corresponding to the raw report point, and generating an optimization report point corresponding to the raw report point according to the raw report point and the optimization curve, where i and j are positive integers.

### BACKGROUND OF THE INVENTION

1. Field of the Invention

The present invention relates to a system for optimizing touch tracks and a method for optimizing touch tracks, and particularly to a system for optimizing touch tracks and a method for optimizing touch tracks that can utilize a linear optimization method to reduce shift between raw report points generated by touch operation and a real touch track.

2. Description of the Prior Art

Please refer to FIG. 1. FIG. 1 is a diagram illustrating a user utilizing a finger to execute touch operation on a touch panel. As shown in FIG. 1, when a user utilizes a finger 102 to execute touch operation on a touch panel 104, a capacitance of a touch point on the touch panel 104 is increased due to a capacitive coupling effect of the finger 102, so a processor 106 coupled to the touch panel 104 can detect and calculate a position of the touch point according to variation of the capacitance of the touch point. Further, when the finger 102 executes touch operation on the touch panel 104, capacitance variation of each sensing unit (dotted line circles as shown in FIG. 1) touched by the finger 102 on a moving path of the finger 102 can be varied with a contact area between each sensing unit and the finger 102.

Please refer to FIG. 2. FIG. 2 is a diagram illustrating a relationship between report points generated by the processor 106 according to capacitance variation of each sensing unit and a real touch track generated by the finger 102. As shown in FIG. 2, because a parasitic capacitors of each sensing unit is different, sensing capability of each sensing unit is also different, resulting in a position of a touch point generated by the finger 102 being slightly different from a report point generated by the processor 106 according to capacitance variation of the touch point. Thus, because linearity of a track composed of positions of report points generated by the processor 106 is usually lower, the prior art has a bad influence on linear behavior of touch operation.

### SUMMARY OF THE INVENTION

An embodiment provides a system for optimizing touch tracks. The system includes a touch panel, a register, and a processor. The processor is used for receiving a plurality of touch signals of the touch panel, calculating a plurality of raw report points of the touch panel according to the plurality of touch signals, storing the plurality of raw report points in the register, utilizing a linear optimization method to generate an optimization curve corresponding to each raw report point of the plurality of raw report points according to previous i raw report points and following j raw report points of the plurality of raw report points corresponding to the raw report point, and generating an optimization report point corresponding to the raw report point according to the raw report point and the optimization curve, where i and j are positive integers.

Another embodiment provides a method for optimizing touch tracks, where a system for optimizing touch tracks includes a touch panel, a register, and a processor. The method includes the processor receiving a plurality of touch signals of the touch panel; the processor calculating a plurality of raw report points of the touch panel according to the plurality of touch signals, and storing the plurality of raw report points in the register; the processor utilizing a linear optimization method to generate an optimization curve corresponding to each raw report point of the plurality of raw report points according to previous i raw report points and following j raw report points of the plurality of raw report points corresponding to the raw report point; and the processor generating an optimization report point corresponding to the raw report point according to the raw report point and the optimization curve; where i and j are positive integers.

The present invention provides a system for optimizing touch tracks and a method for optimizing touch tracks. The system and the method utilize a processor to generate an optimization curve corresponding to each raw report point according to a linear optimization method and previous i raw report points and following j raw report points of the raw report point. Then, the processor can generate an optimization report point corresponding to the raw report point according to the raw report point and the optimization curve corresponding to the raw report point. Therefore, compared to the prior art, the present invention has advantages as follows: first, the linear optimization method can effectively reduce shift between raw report points generated by touch operation and a real touch track caused by a finger; second, the present invention can be applied to structures of various sensing units; and third, the present invention can provide a more flexible design requirement to a sensing unit to increase sensing accuracy of the sensing unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a user utilizing a finger to execute touch operation on a touch panel.

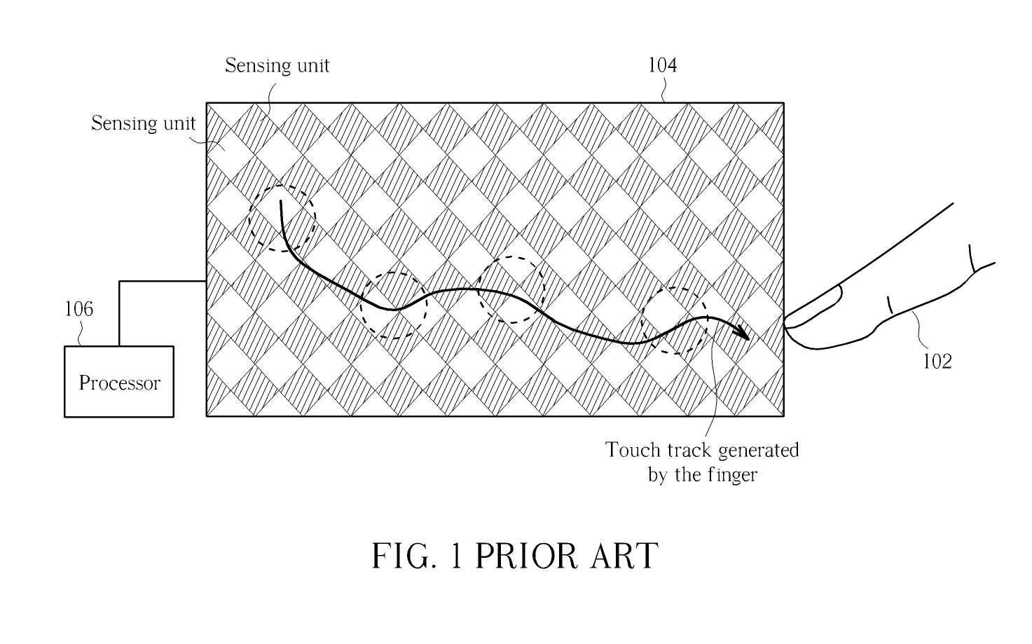

FIG. 2 is a diagram illustrating a relationship between report points generated by the processor according to capacitance variation of each sensing unit and a real touch track generated by the finger.

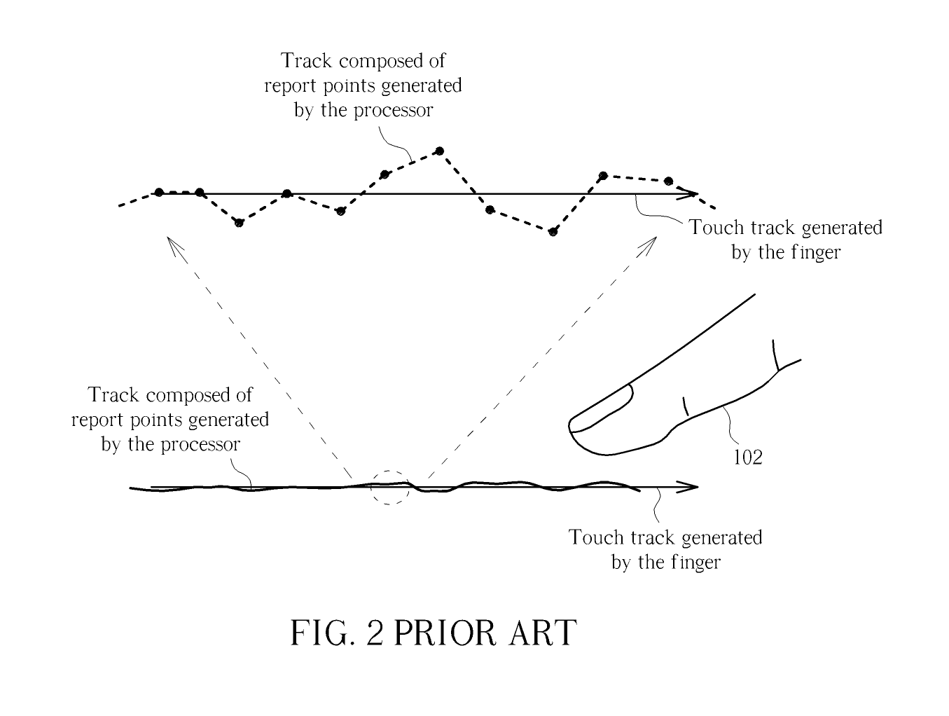

FIG. 3 is a diagram illustrating a system for optimizing touch tracks according to an embodiment.

FIG. 4 is a diagram illustrating an object touching a touch panel.

FIG. 5 is a diagram illustrating the processor utilizing a linear optimization method to generate an optimization curve corresponding to each raw report point according to a previous raw report point and a following raw report point of the raw report point.

FIG. 6 is a diagram illustrating relationships of a track composed of a plurality of raw report points, a track composed of optimization report points corresponding to a plurality of raw report points, and a real touch track generated by the finger.

FIG. 7 is a diagram illustrating the processor utilizing a linear optimization method to generate an optimization curve corresponding to a raw report point according to previous two raw report points and following two raw report points of the raw report point.

FIG. 8 is a diagram illustrating the processor utilizing a linear optimization method to generate an optimization curve corresponding to a raw report point according to previous i raw report points and following j raw report points of the raw report point.

FIG. 9 is a diagram illustrating the processor determining whether to neglect a raw report point according to an average value corresponding to the raw report point according to another embodiment of the present invention.

FIG. 10 is a flowchart illustrating a method for optimizing touch tracks according to another embodiment.

### DETAILED DESCRIPTION

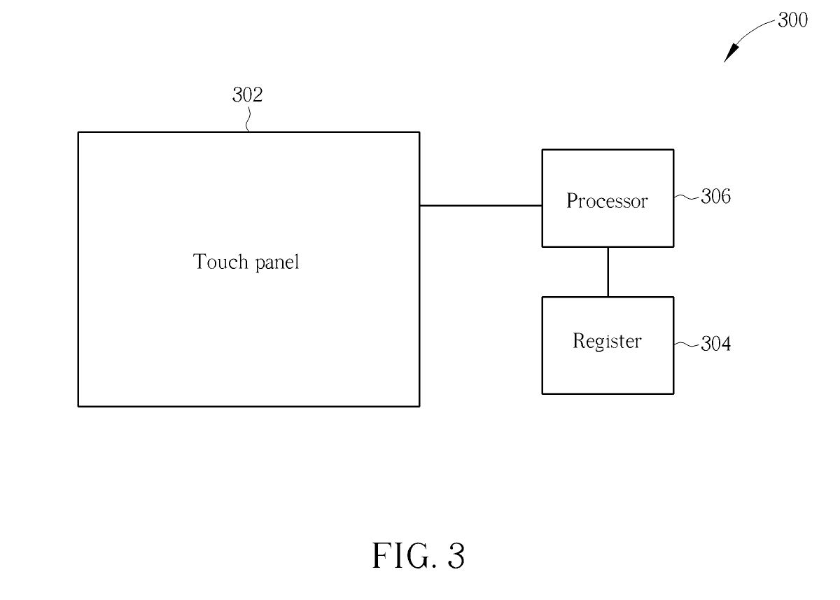

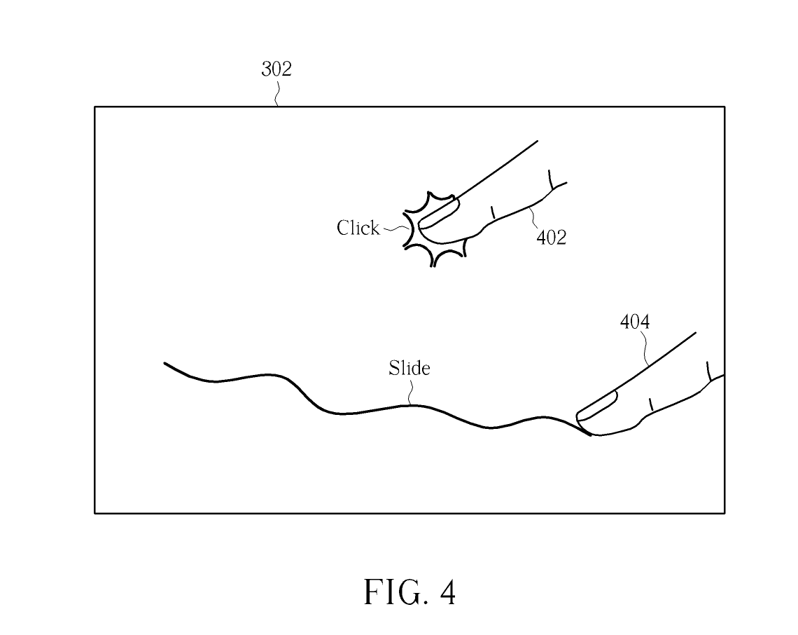

Please refer to FIG. 3 and FIG. 4. FIG. 3 is a diagram illustrating a system 300 for optimizing touch tracks according to an embodiment, and FIG. 4 is a diagram illustrating an object touching a touch panel. The system 300 includes a touch panel 302, a register 304, and a processor 306. As shown in FIG. 4, when an object (e.g. a finger 402) clicks the touch panel 302, the touch panel 302 generates a touch signal according to a position of the finger 402. Therefore, after the processor 306 receives the touch signal of the touch panel 302, the processor 306 can determine that the touch signal of the touch panel 302 corresponds to a click according to the touch signal of the touch panel 302. Therefore, the processor 306 can calculate a raw report point of the touch panel 302 according to the touch signal of the touch panel 302, and execute a corresponding operation on the touch panel 302 according to a position of the raw report point. For example, the processor 306 can enable an application program on the touch panel 302.

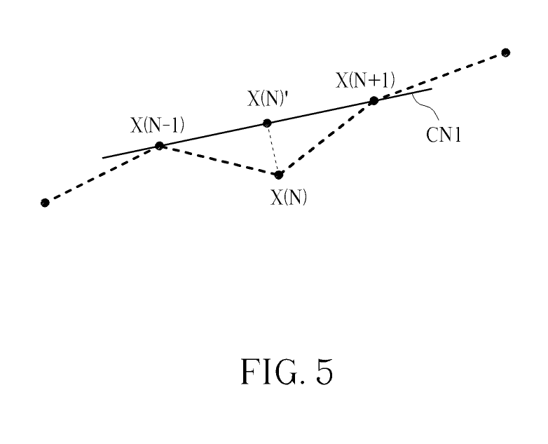

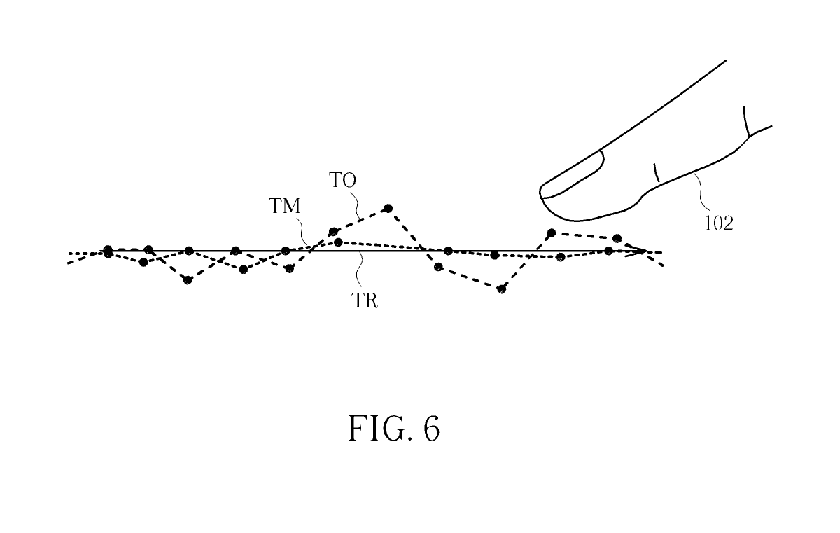

In addition, when an object (e.g. a finger 404) slides on the touch panel 302, the touch panel 302 generates a plurality of touch signals according to positions of the finger 404. That is to say, the touch panel 302 generates a plurality of sequential and adjacent touch signals according to the positions of the finger 404. The processor 306 can receive the plurality of touch signals of the touch panel 302, calculate a plurality of raw report points of the touch panel 302 according to the plurality of touch signals of the touch panel 302, and store the plurality of raw report points of the touch panel 302 to the register 304. Please refer to FIG. 5. FIG. 5 is a diagram illustrating the processor 306 utilizing a linear optimization method to generate an optimization curve CN1 corresponding to each raw report point X(N) of the plurality of raw report points according to a previous raw report point X(N−1) and a following raw report point X(N+1) of the plurality of raw report points corresponding to the raw report point X(N). As shown in FIG. 5, the processor 306 utilizes the linear optimization method to generate the optimization curve CN1 corresponding to the raw report point X(N) according to the raw report point X(N−1) and the raw report point X(N+1), where the linear optimization method can be a moving average method, a weighted moving average method, a least-square method, or an exponential smoothing method. But, the present invention is not limited to the linear optimization method being the moving average method, the weighted moving average method, the least-square method, or the exponential smoothing method. Any configuration in which the processor 306 utilizes a plurality of raw report points to generate an optimization curve falls within the scope of the present invention. Then, the processor 306 can generate an optimization report point X(N)′ corresponding to the raw report point X(N) according to the raw report point X(N) and the optimization curve CN1. For example, the processor 306 can project the raw report point X(N) to the optimization curve CN1 to generate the optimization report point X(N)′ corresponding to the raw report point X(N). But, the present invention is not limited to the processor 306 projecting the raw report point X(N) to the optimization curve CN1 to generate the optimization report point X(N)′ corresponding to the raw report point X(N). Please refer to FIG. 6. FIG. 6 is a diagram illustrating relationships of a track TO composed of a plurality of raw report points, a track TM composed of optimization report points corresponding to a plurality of raw report points, and a real touch track TR generated by the finger 404. As shown in FIG. 6, the track TM is closer to the real touch track TR than the track TO.

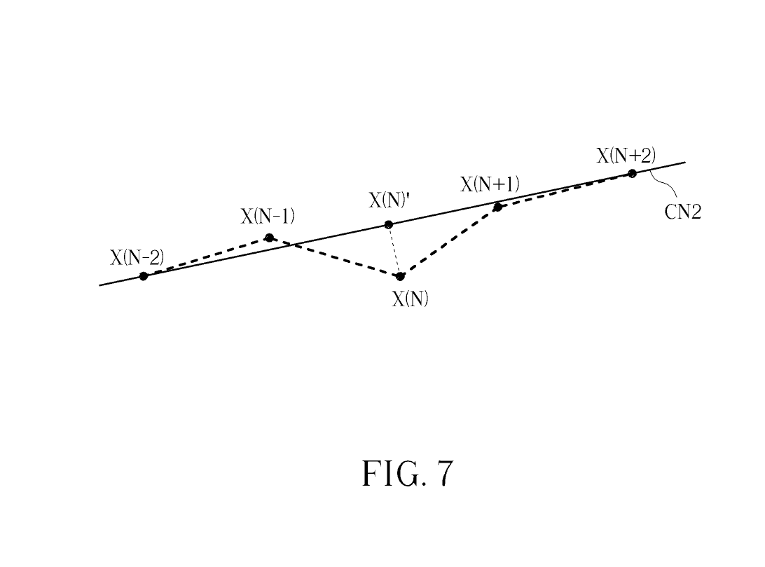

Please refer to FIG. 7. FIG. 7 is a diagram illustrating the processor 306 utilizing a linear optimization method to generate an optimization curve CN2 corresponding to a raw report point X(N) of the plurality of raw report points according to previous two raw report points X(N−1), X(N−2) and following two raw report points X(N+1), X(N+2) of the plurality of raw report points corresponding to the raw report point X(N). As shown in FIG. 7, the processor 306 utilizes the linear optimization method to generate the optimization curve CN2 corresponding to the raw report point X(N) according to the raw report points X(N−1), X(N−2), X(N+1), and X(N+2). Then, the processor 306 can generate an optimization report point X(N)′ corresponding to the raw report point X(N) according to the raw report point X(N) and the optimization curve CN2.

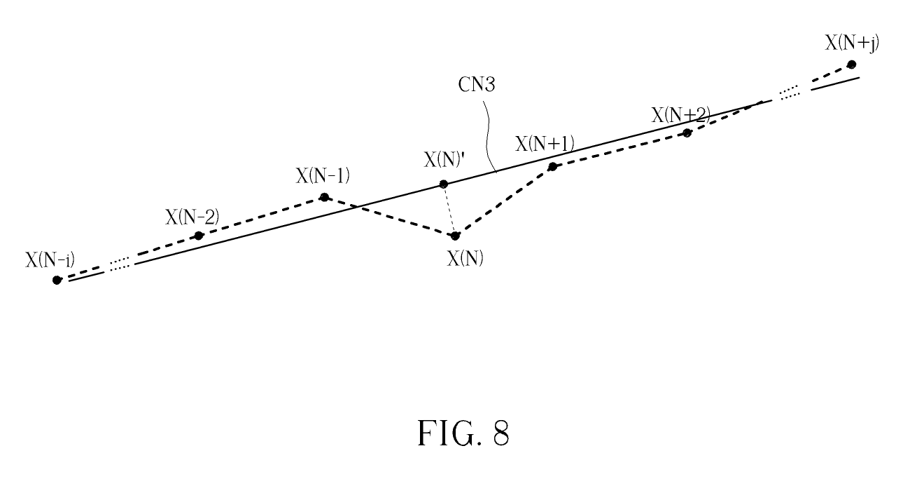

Please refer to FIG. 8. FIG. 8 is a diagram illustrating the processor 306 utilizing a linear optimization method to generate an optimization curve CN3 corresponding to a raw report point X(N) of the plurality of raw report points according to previous i raw report points X(N−1), . . . , X(N−i) and following j raw report points X(N+1), . . . , X(N+j) of the plurality of raw report points corresponding to the raw report point X(N), where i and j can be the same or the different, and i and j are positive integers. But, in another embodiment if the present invention, i is not equal to j . As shown in FIG. 8, the processor 306 utilizes the linear optimization method to generate the optimization curve CN3 corresponding to the raw report point X(N) according to the raw report points X(N−1), . . . , X(N−i) and X(N+1), . . . , X(N+j). Then, the processor 306 can generate an optimization report point X(N)′ corresponding to the raw report point X(N) according to the raw report point X(N) and the optimization curve CN3.

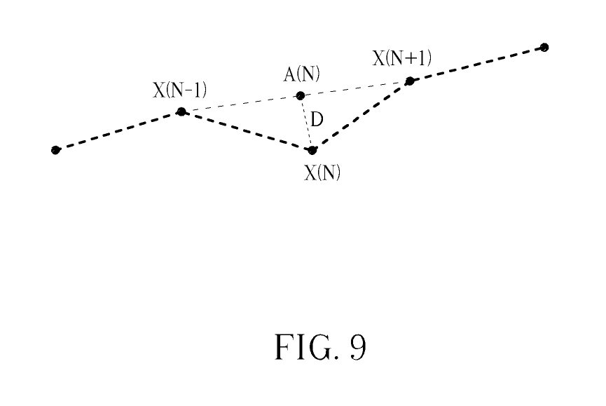

In addition, please refer to FIG. 9. FIG. 9 is a diagram illustrating the processor 306 determining whether to neglect a raw report point X(N) of the plurality of raw report points according to an average value corresponding to the raw report point X(N) according to another embodiment of the present invention. As shown in FIG. 9, the processor 306 can first calculate an average value A(N) of a previous raw report point X(N−1) and a following raw report point X(N+1) of each raw report point X(N). When a distance D between the average value A(N) and the raw report point X(N) is greater than a predetermined value, the processor 306 neglects the raw report point X(N). That is to say, the processor 306 does not generate an optimization report point corresponding to the raw report point X(N) according to the raw report point X(N). Because it is meant that a relationship between the raw report point X(N) and other raw report points is weaker when the distance D between the average value A(N) and the raw report point X(N) is greater than the predetermined value, the processor 306 neglects the raw report point X(N) to make a track composed of optimization report points be closer to a real touch track on the touch panel 302 generated by a finger.

In another embodiment of the present invention, after the processor 306 first generates first optimization report points corresponding to a plurality of raw report points according to the plurality of raw report points, the processor 306 can utilize the above mentioned method again to generate second optimization report points corresponding to the first optimization report points according to the first optimization report points. Then, the processor 306 can utilize a track composed of the second optimization report points to represent a real touch track on the touch panel 302 generated by a finger. Therefore, any configuration in which the processor 306 utilizes the linear optimization method to generate an optimization curve according to a plurality of raw report points generated by the processor 306 falls within the scope of the present invention.

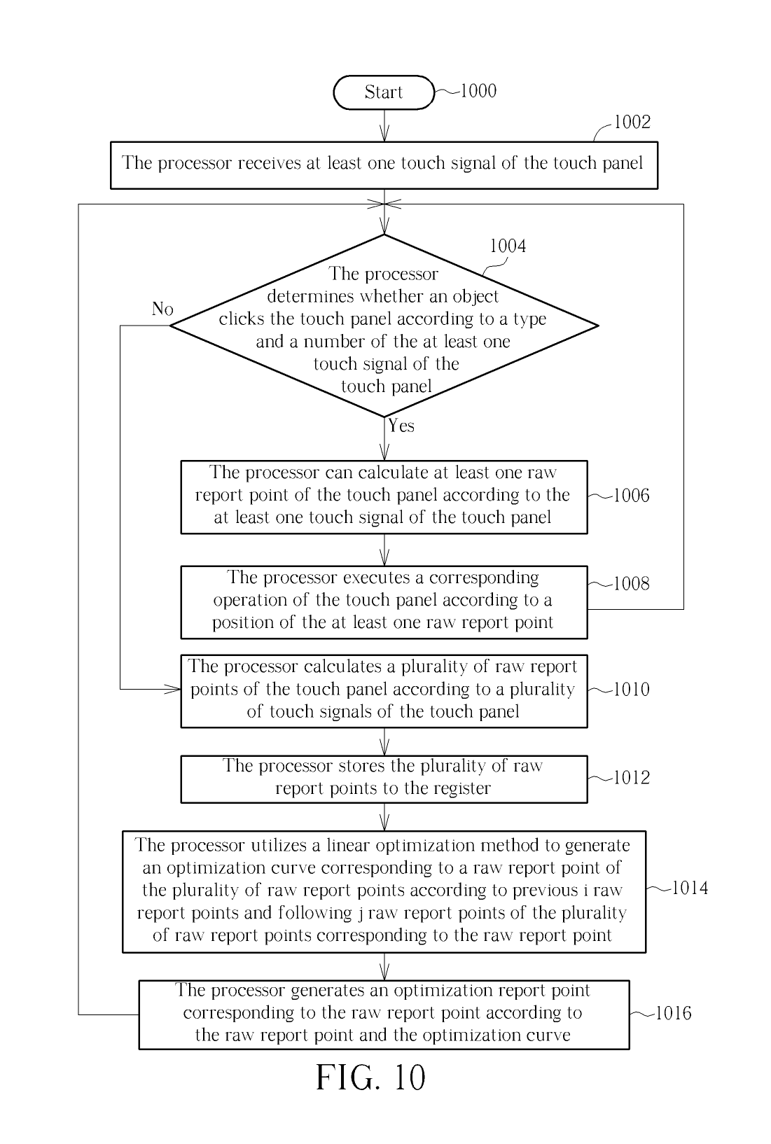

Please refer to FIG. 3 to FIG. 10. FIG. 10 is a flowchart illustrating a method for optimizing touch tracks according to another embodiment. The method in FIG. 10 is illustrated using the system 300 in FIG. 3. Detailed steps are as follows:

Step 1000: Start.

Step 1002: The processor 306 receives at least one touch signal of the touch panel 302.

Step 1004: The processor 306 determines whether an object clicks the touch panel 302 according to a type and a number of the at least one touch signal of the touch panel 302; if yes, go to Step 1006; if no, go to Step 1010.

Step 1006: The processor 306 can calculate at least one raw report point of the touch panel 302 according to the at least one touch signal of the touch panel 302.

Step 1008: The processor 306 executes a corresponding operation of the touch panel 302 according to a position of the at least one raw report point, go to Step 1004.

Step 1010: The processor 306 calculates a plurality of raw report points of the touch panel 302 according to a plurality of touch signals of the touch panel 302.

Step 1012: The processor 306 stores the plurality of raw report points to the register 304.

Step 1014: The processor 306 utilizes a linear optimization method to generate an optimization curve corresponding to a raw report point X(N) of the plurality of raw report points according to previous i raw report points and following j raw report points of the plurality of raw report points corresponding to the raw report point X(N).

Step 1016: The processor 306 generates an optimization report point corresponding to the raw report point X(N) according to the raw report point X(N) and the optimization curve, go to Step 1004.

In Step 1002, as shown in FIG. 4, when the object (e.g. the finger 402) clicks the touch panel 302, the touch panel 302 generates a touch signal corresponding to a click according to a position of the finger 402. In Step 1004, after the processor 306 receives the touch signal of the touch panel 302, the processor 306 can determine that the touch signal of the touch panel 302 corresponds to the click according to the touch signal of the touch panel 302. In Step 1006, the processor 306 calculates a raw report point of the touch panel 302 according to the touch signal of the touch panel 302. In Step 1008, the processor 306 can execute a corresponding operation of the touch panel 302 according to a position of the raw report point. For example, the processor 306 can enable an application program of the touch panel 302.

In addition, as shown in FIG. 4, when the object (e.g. the finger 404) slides of the touch panel 302, the touch panel 302 generates a plurality of touch signals according to positions of the finger 404. That is to say, the touch panel 302 generates a plurality of sequential and adjacent touch signals according to the positions of the finger 404. Therefore, in Step 1002 and Step 1004, the processor 306 receives the plurality of touch signals of the touch panel 302, and determines the object (e.g. the finger 404) not to click touch panel 302 according to the plurality of sequential and adjacent touch signals of the touch panel 302. In Step 1010 and Step 1012, the processor 306 can calculate the plurality of raw report points of the touch panel 302 according to the plurality of touch signals of the touch panel 302, and stores the plurality of raw report points to the register 304.

In Step 1014 and Step 1016, as shown in FIG. 5, the processor 306 utilizes the linear optimization method to generate the optimization curve CN1 corresponding to the raw report point X(N) according to the raw report point X(N−1) and the raw report point X(N+1), where the linear optimization method can be a moving average method, a weighted moving average method, a least-square method, or an exponential smoothing method. But, the present invention is not limited to linear optimization method being the moving average method, the weighted moving average method, the least-square method, or the exponential smoothing method. Then, the processor 306 can generate the optimization report point X(N)′ corresponding to the raw report point X(N) according to the raw report point X(N) and the optimization curve CN1. For example, the processor 306 can project the raw report point X(N) to the optimization curve CN1 to generate the optimization report point X(N)′ corresponding to the raw report point X(N). But, the present invention is not limited to the processor 306 projecting the raw report point X(N) to the optimization curve CN1 to generate the optimization report point X(N)′ corresponding to the raw report point X(N). As shown in FIG. 6, the track TM composed of optimization report points is closer to the real touch track TR generated by the finger 404 than the track TO composed of a plurality of raw report points.

In addition, take FIG. 7 as an example.

In Step 1014 and Step 1016, the processor 306 utilizes the linear optimization method to generate the optimization curve CN2 corresponding to the raw report point X(N) according to the raw report points X(N−1), X(N−2), X(N+1), and X(N+2). Then, the processor 306 can generate the optimization report point X(N)′ corresponding to the raw report point X(N) according to the raw report point X(N) and the optimization curve CN2.

In addition, take FIG. 8 as an example.

In Step 1014 and Step 1016, the processor 306 utilizes the linear optimization method to generate the optimization curve CN3 corresponding to the raw report point X(N) according to the raw report points X(N−1), . . . , X(N−i) and X(N+1), . . . , X(N+j). Then, the processor 306 can generate the optimization report point X(N)′ corresponding to the raw report point X(N) according to the raw report point X(N) and the optimization curve CN3, where i and j can be the same or the different, and i and j are positive integers.

In addition, as shown in FIG. 9, the processor 306 can first calculate the average value A(N) of the previous raw report point X(N−1) and the following raw report point X(N+1) of each raw report point X(N) in another embodiment of the present invention. When the distance D between the average value A(N) and the raw report point X(N) is greater than a predetermined value, the processor 306 neglects the raw report point X(N). That is to say, the processor 306 does not generate an optimization report point corresponding to the raw report point X(N) according to the raw report point X(N). Because it is meant that a relationship between the raw report point X(N) and other raw report points is weaker when the distance D between the average value A(N) and the raw report point X(N) is greater than the predetermined value, the processor 306 neglects the raw report point X(N) to make a track composed of optimization report points be closer to a real touch track of the touch panel 302 generated by a finger.

In addition, in another embodiment of the present invention, after the processor 306 first generates first optimization report points corresponding to a plurality of raw report points according to the plurality of raw report points, the processor 306 can utilize the above mentioned method again to generate second optimization report points corresponding to the first optimization report points according to the first optimization report points. Then, the processor 306 can utilize a track composed of the second optimization report points to represent a real touch track of the touch panel 302 generated by a finger. Therefore, any configuration in which the processor 306 utilizes the linear optimization method to generate an optimization curve according to a plurality of raw report points generated by the processor 306 falls within the scope of the present invention.

To sum up, the system for optimizing touch tracks and the method for optimizing touch tracks utilize the processor to generate an optimization curve corresponding to each raw report point according to the linear optimization method and previous i raw report points and following j raw report points of each raw report point. Then, the processor can generate an optimization report point corresponding to each raw report point according to each raw report point and an optimization curve corresponding to each raw report point. Therefore, compared to the prior art, the present invention has advantages as follows: first, the linear optimization method can effectively reduce shift between raw report points generated by touch operation and a real touch track caused by a finger; second, the present invention can be applied to structures of various sensing units; and third, the present invention can provide a more flexible design requirement to a sensing unit to increase sensing accuracy of the sensing unit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for optimizing touch tracks, the system comprising:
a touch panel;
a register; and
a processor for receiving a plurality of touch signals of the touch panel, calculating a plurality of raw report points of the touch panel according to the plurality of touch signals, storing the plurality of raw report points in the register, utilizing a linear optimization method to generate an optimization curve corresponding to each raw report point of the plurality of raw report points according to previous i raw report points and following j raw report points of the plurality of raw report points corresponding to the raw report point, and generating an optimization report point corresponding to the raw report point according to the raw report point and the optimization curve;
wherein i and j are positive integers.

2. The system of claim 1, wherein i is not equal to j.

3. The system of claim 1, wherein i is equal to j.

4. The system of claim 1, wherein the linear optimization method is a moving average method, a weighted moving average method, a least-square method, or an exponential smoothing method.

5. The system of claim 1, wherein the processor is further used for neglecting the raw report point when a distance between an average value of the previous i raw report points and the following j raw report points and the raw report point is greater than a predetermined value.

6. A method for optimizing touch tracks adapted to a system for optimizing touch tracks, the system comprising a touch panel, a register, and a processor, the method comprising:
the processor receiving a plurality of touch signals of the touch panel;
the processor calculating a plurality of raw report points of the touch panel according to the plurality of touch signals, and storing the plurality of raw report points in the register;
the processor utilizing a linear optimization method to generate an optimization curve corresponding to each raw report point of the plurality of raw report points according to previous i raw report points and following j raw report points of the plurality of raw report points corresponding to the raw report point; and
the processor generating an optimization report point corresponding to the raw report point according to the raw report point and the optimization curve;
wherein i and j are positive integers.

7. The method of claim 6, wherein i is not equal to j.

8. The method of claim 6, wherein i is equal to j.

9. The method of claim 6, wherein the linear optimization method is a moving average method, a weighted moving average method, a least-square method, or an exponential smoothing method.

10. The method of claim 6, further comprising:
the processor neglecting the raw report point when a distance between an average value of the previous i raw report points and the following j raw report points and the raw report point is greater than a predetermined value.
